(19) United States
(12) Patent Application Publication
(10) Pub. No.: US 2006/0129810 A1
(43) Pub. Date: Jun. 15, 2006

(54) Method and apparatus for evaluating security of subscriber network

(75) Inventors: Youn Seo Jeong, Daejeon-city (KR); Yang Seo Choi, Daejeon-city (KR); Won Joo Park, Daejeon-city (KR); Seung Hee Oh, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/302,476

(22) Filed: Dec. 12, 2005

(30) Foreign Application Priority Data
Dec. 14, 2004 (KR) 10-2004-0105429
Jun. 30, 2005 (KR) 10-2005-0058362

(51) Int. Cl. H04L 9/00

(52) U.S. Cl. 713/166

(57) ABSTRACT

A method and apparatus for evaluating the security of a subscriber network are provided. In the method and apparatus for evaluating the security of a subscriber network, pieces of information regarding a plurality of security functions provided by each of a plurality of network security devices connected to a network are collected, and the security functions are classified according to their types, purposes of use, and priority levels. Scores are given to the security functions using weights with reference to the classification results, and a security level for the network is determined by summing the scores of the security functions. Therefore, it is possible to objectively evaluate how secure a network is against cyber attacks launched internally or externally upon the network. In addition, it is possible to evaluate security functions provided by network security devices in a network in advance and enhance the performance of the security functions based on the evaluation results.

### CROSS-REFERENCE TO RELATED PATENT APPLICATION

This application claims the benefit of Korean Patent Application Nos. 10-2004-0105429 and 10-2005-0058362, filed on 14 Dec. 2004 and 30 Jun. 2005, respectively, in the Korean Intellectual Property Office, the disclosures of which are incorporated herein in their entirety by reference.

### BACKGROUND OF THE INVENTION

1. Field of the Invention

The present invention relates to the protection of information in a communication network, and more particularly, to a method and apparatus for evaluating the security of a subscriber network.

2. Description of the Related Art

Recently, an increasing number of cyber attacks have been launched against network infrastructures, and an increasing number of network breakdowns have occurred worldwide due to the spread of malicious code, such as worms. Accordingly, more public attention has been drawn to strengthening information security at an end user than to taking measures on a host level to protect end users in a network. Therefore, it is necessary to complement existing network security functions, which are yet to be perfect, with the analysis of the security levels of networks before the networks are completely paralyzed by cyber attacks or malicious code.

However, no specific benchmarks regarding the security levels of networks have been established. Research has been carried out in domestic and foreign countries mainly focusing on ways to evaluate the security levels of networks for network management, but the results have not yet been proven to be of practical use to protecting information in networks.

### SUMMARY OF THE INVENTION

The present invention provides a method and apparatus for evaluating the security of a subscriber network in which risks control can be effectively and efficiently carried out on a network by examining and analyzing various information protection functions provided by the network using an objective and quantitative method.

According to an aspect of the present invention, there is provided a method of evaluating the security of a subscriber network. The method includes: receiving a plurality of pieces of information regarding a plurality of security functions provided by a plurality of network security devices connected to the subscriber network; classifying the security functions according to the types, the purposes of use, and the priority levels of the security functions for each of the network security devices; giving scores to and applying weights to the security functions with reference to the classification results; and determining a security level for the subscriber network by summing the scores given to the security functions.

According to another aspect of the present invention, there is provided an apparatus for evaluating the security of a subscriber network. The apparatus includes: an information receiving unit which receives a plurality of pieces of information regarding a plurality of security functions provided by each of a plurality of network security devices connected to the subscriber network; a classification unit which classifies the security functions according to the types, the purposes of use, and the priority levels of the security functions for each of the network security devices; a grading unit which gives scores to and applies weights to the security functions with reference to the classification results; and a determination unit which determines a security level for the subscriber network by summing the scores given to the respective security functions.

### BRIEF DESCRIPTION OF THE DRAWINGS

The above and other features and advantages of the present invention will become more apparent by describing in detail; exemplary embodiments thereof with reference to the attacked drawings in which:

FIG. 1 is a flowchart illustrating a method of evaluating the security of a subscriber network according to an exemplary embodiment of the present invention; and

FIG. 2 is a block diagram of an apparatus for evaluating the security of a subscriber network according to an exemplary embodiment of the present invention.

### DETAILED DESCRIPTION OF THE INVENTION

The present invention will now be described more fully with reference to the accompanying drawings in which exemplary embodiments of the invention are shown.

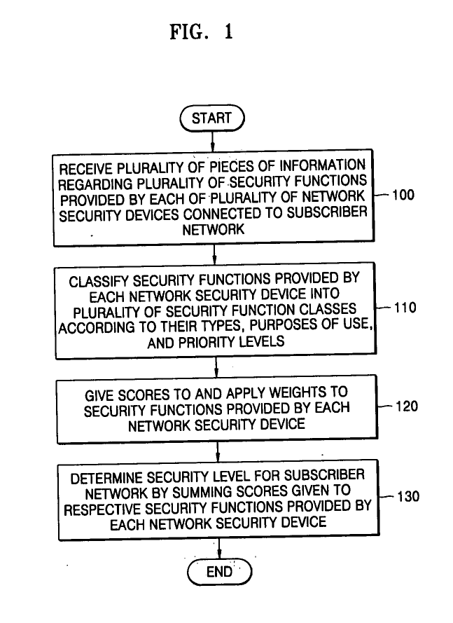

FIG. 1 is a flowchart illustrating a method of evaluating the security of a subscriber network according to an exemplary embodiment of the present invention. Referring to FIG. 1, the method includes: receiving information regarding a plurality of security functions provided by each of a plurality of network security devices connected to a subscriber network (operation 100); classifying the security functions into a plurality of security function classes according to the types and priority levels of the security functions and according to the advantages provided by the security functions for each of the network security devices (operation 110); giving scores to the security functions (operation 120); and determining a security level for the subscriber network with reference to the scores given to the respective security functions.

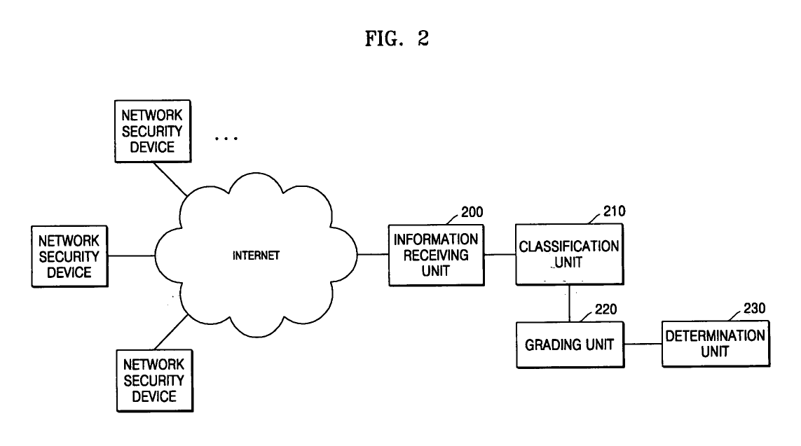

FIG. 2 is a block diagram of an apparatus for evaluating the security of a subscriber network according to an exemplary embodiment of the present invention. Referring to FIG. 2, the apparatus includes an information receiving unit 200 which receives a collection of pieces of information regarding a plurality of security functions provided by each of a plurality of network security devices connected to a subscriber network, a classification unit 210 which classifies the security functions into a plurality of security function classes according to the types and levels of significance of the security functions and according to advantages provided by the security functions, a grading unit 220 which gives scores to the security function classes, and a determination unit 230 which determines a security level for the subscriber network with reference to the ,scores given to the respective security function classes for each of the network security devices.

Referring to FIGS. 1 and 2, in operation 100, the information receiving unit 200 receives the plurality of pieces of information regarding the plurality of security functions provided by each of the plurality of network security devices connected to the subscriber network. The information regarding the security functions is input to the apparatus by a user (e.g., a network administrator). If a standard regarding the security functions has already been prescribed, the apparatus can automatically obtain via the subscriber network necessary information regarding the security functions provided by each of the network security devices. However, no specific benchmarks regarding how to collect information regarding the security functions have been established in the prior art. Thus, the network administrator examines and analyzes the security functions, and the apparatus handles the results of the analysis provided by the network administrator.

The information received by the information receiving unit 200 in operation 100 includes information regarding what types of network attacks to detect and how to detect network attacks, information regarding how to respond to network attacks, information indicating whether a system to which the network security devices are connected provides security functions of its own, information regarding a method of providing stability to the subscriber network, and information regarding how to operate the system, and each of these pieces of information will be described later in detail.

In operation 110, the classification unit 210 classifies the security functions into the plurality of security function classes according to the types and the significance of the security functions and according to the advantages provided by the security functions for each of the network security devices.

In operation 110, the classification unit 210 may classify the security functions into a network attack detection section and a network attack handling section. The security functions belonging to the network attack detection section are used for detecting attacks launched externally or internally against the subscriber network, and the security functions belonging to the network attack handling section are used for protecting the subscriber network from network attacks.

The security functions belonging to the network attack detection section may be further classified into a packet analysis group, a correlation analysis group that includes security functions for anomaly mode detection, and a detection pattern application group according to how they detect a network attack and what types of network attack detection patterns they adopt.

In detail, the security functions belonging to the packet analysis group may be further classified into a packet level analysis class, a session level analysis class, and an application level analysis class according to how they detect a network attack. The security functions belonging to the packet level analysis class are for detecting a network attack on a packet level with reference to IP header information of packets input to the subscriber network. The security functions belonging to the session level analysis class are for detecting a network attack with reference to session state information. The security functions belonging to the application level analysis class are for detecting a network attack by analysing all data transmitted via the subscriber network.

The security functions belonging to the correlation analysis group may be further classified according to the levels of correlation analysis they adopt. In detail, the security functions belonging to the correlation analysis group may be further classified into a fixed threshold application class and a variable threshold application class according to whether a fixed threshold independent of the state of the subscriber network is used or whether a variable threshold depending on the state of the subscriber network is used. In addition, the security functions belonging to the correlation analysis group may be further classified into a single information correlation analysis class and a multiple information correlation analysis class according to whether information is collected from a single server or from a plurality of servers.

One of the biggest problems facing existing network security techniques is false positives and false negatives. For example, according to existing network attack detection functions, when a packet with the same signature as a signature possessed by a network security device is detected, the network security device is notified of the detection of the packet. However, a small number of packets may not wreak havoc on a subscriber network regardless of how dangerous they are. On the other hand, even normal packets could turn into dangerous packets attacking a subscriber network when they band together. Therefore, a signature-based network attack detection method using simple pattern matching is highly likely to end up high false positive or negative rates. Accordingly, it is necessary to analyze through correlation analysis various information collected from a plurality of information sources, previous or subsequent network attack detection information, and accumulated pattern information in conjunction with one another while taking a time factor into consideration.

Correlation analysis provides various ways to reinterpret network attack detection factors while taking into consideration as many combinations of the network attack detection factors as possible. Thus, a network security manager can effectively perform risk control on the subscriber network with less effort through correlation analysis.

The security functions belonging to the detection pattern application group may be further classified into a signature pattern class, a weakness information pattern class, and a protocol inspection pattern class according to the types of detection patterns they adopt. In detail, the security functions belonging to the signature pattern class are functions adopting a network attack detection pattern (i.e., a signature) which is created to handle a network attack after the network attack is launched upon the subscriber network. The security functions belonging to the weakness information pattern class are functions adopting a signature created based on information regarding weaknesses of the subscriber network before a network attack is launched against the subscriber network. The security functions belonging to the protocol inspection pattern class are used to determine whether packets input to the subscriber network have been created in compliance with protocol stacks or standards. For example, if a plurality of flags are simultaneously set in an IP packet, SYN and FIN flags may be set together or all of the flags in the IP packet may be simultaneously set.

The security functions belonging to the network attack detection section may be further classified into an abnormal excessive traffic detection group, a virus/worm detection group, and a typical hacking prevention group according to the threats they detect. The abnormal excessive traffic detection group includes security functions that detect excessive traffic information.

It can be determined whether a cyber attack is launched upon a network by detecting, for example, unusually excessive traffic related to a Denial of Service (DoS) attack. Viruses or worms can be detected by determining whether there are attack programs that attempt to access predetermined address areas that normal programs would not attempt to access. Typical hacking can be detected by detecting abnormal operations occurring in a network. Various threats can be detected in various manners other than those set forth herein.

In operation 110, the security functions belonging to the network attack handling section are further classified into a packet control group that includes security functions that disallow the transmission of packets associated with a network attack and a bandwidth control group that includes security functions that block packets which are determined to be outside a predetermined bandwidth. The security functions belonging to the packet control group may be further classified into a packet level control class that includes security functions that perform packet control on a packet level, a session level control class that includes security functions that perform packet control on a session level by terminating sessions associated with a network attack, and a content level control class that includes security functions that perform packet control on a packet content level by determining whether to disallow transmission of packets based on the contents of the packets. The security functions belonging to the bandwidth control group may be further classified into a fixed threshold application class and a variable threshold application class. The security functions belonging to the fixed threshold application class use a threshold determined in advance. by a network manager when handling a network attack, while the security functions belonging to the variable threshold application class use a variable threshold which is obtained through self-learning according to network conditions.

The variable threshold obtained through self-learning may be, for example, 30% of the average traffic for the past 3 months. In this case, if current traffic exceeds 30% of the average traffic for the past 3 months, bandwidth control may be performed on the current traffic, thereby protecting the network. In short, the variable threshold obtained through self-learning may be determined in consideration of the properties of a network by a network manager, and thus may vary according to the circumstances in the network.

The above-mentioned classifications of the security functions provided by each of the network security devices connected to the subscriber network, according to whether the security functions are for detecting network attacks or for responding to network attacks, can be summarized as indicated in Table 1, which presents a plurality of security function sections, divisions, groups, and classes and scores given to the respective security function classes in operation 120.

TABLE 1

| Sections | Divisions | Groups | Classes | Scores |
|---|---|---|---|---|
| Network | Detection | Packet Analysis | Packet Level Analysis | 1 |
| Attack | Methods | | Session Level Analysis | 3 |
| Detection | | | Application Level Analysis | 6 |
| | | Correlation Analysis | Fixed Threshold Application | 1 |
| | | | Variable Threshold Application | 3 |
| | | | Single Information Correlation | 2 |
| | | | Analysis | |
| | | | Multiple Information Correlation | 4 |
| | | | Analysis | |
| | | Detection Pattern | Signature Pattern | 2 |
| | | | Weakness Information Pattern | 3 |
| | | | Protocol Inspection Pattern | 5 |
| | Detection | Abnormal Excessive | | 10 |
| | Targets | Traffic Detection | | |
| | | Virus/Worm Detection | | 10 |
| | | Typical Hacking | | 10 |
| | | Detection | | |
| Network | | Packet Control | Packet Level Control | 1 |
| Attack | | | Session Level Control | 3 |
| Handling | | | Content Level Control | 6 |
| | | Bandwidth Control | Fixed Threshold Application | 3 |
| | | | Variable Threshold Application | 7 |

The security of systems served by network security devices may affect the security of a network including the systems, and thus needs to be taken into account when establishing the network. Therefore, in operation 110, the security functions provided by each of the network security devices connected to the subscriber network may also be classified according to their purposes of use into a system security maintenance section that includes security functions that maintain the security of the systems served by the network security devices, a network stability maintenance section that includes security functions that transmit packets while maintaining the security and stability of the network, and a system management/administration section that includes security functions that effectively manage and administer the systems served by the network security devices.

The security functions belonging to the system security maintenance section may be further classified into a user access control group, a system resource access control group, and an additional functions group. The security functions belonging to the user access control group may be further classified into an ID/password method class that includes security functions that allow only authorized users with legitimate IDs or passwords to access the systems served by the network security devices, a public key infrastructure (PKI) method class that includes security functions that prevent unauthorized users from accessing the systems served by the network security devices using a public key-based method, such as a PKI method, and a biometric authentication method class that includes security functions that allow users who have been successfully identified through biometric authentication to access the systems served by the network security devices. In terms of preventing unauthorized users from accessing the systems served by the network security devices, the security functions belonging to the PKI method class are more effective than the security functions belonging to the ID/password method class, and the security functions belonging to the biometric authentication method class are more effective than the security functions belonging to the PKI method class.

Some of the security functions belonging to the system resource access control group may be further classified into a secure OS class according to whether they use a secure OS to prevent arbitrary attempts to access resources of the systems served by the network security devices.

The security functions belonging to the additional functions group may be further classified into a stealth function class that includes security functions that provide a stealth function which prevents information regarding some functions of the systems served by the network security devices from being exposed, an exclusive OS class that includes security functions that use an exclusive OS for each of the systems served by the network security devices, an exclusive hardware class that includes security functions that use an exclusive hardware system for each of the systems served by the network security devices, and a physical equipment protection class that includes security functions that provide facilities for physically protecting the systems served by the security function. The security functions belonging to the additional functions group may considerably strengthen the security of the systems served by the network security devices by providing various additional functions.

The security functions belonging to the network stability maintenance section may be further classified into a fall-back function group and a load balancing function group according to whether they also provide either a fall-back function or a load balancing function. The fall-back function enables network services to be provided seamlessly even when the network malfunctions, and the load balancing function enables a workload to be uniformly distributed over a plurality of devices connected to the network. The fall-back function and the load balancing function not only maintain the security of the network but also enhance the stability of the network.

The security functions belonging to the system management/administration section may be further classified into an automated real-time signature update class, a centralized security system management class, a monitoring reports/statistical reports management class, a high usability maintenance class, an automated program module/patch update class, and a network zone segmentation class according to whether systems on which the security functions belonging to the system management/administration section are performed provide an automated real-time signature update function, a centralized security system management function, a system operation monitoring reports/statistical reports management function, a high usability maintenance function, an automated program module/patch update function, or a network zone segmentation function.

The automated real-time signature update function, like an automated virus vaccine update function, is for periodically searching for and updating information that needs to be automatically updated under the control of a network manager.

The network zone segmentation function is for segmenting an internal business network into security zones and non-security zones and minimizing unauthorized employees' attempts to access the security zones, quarantining suspicious computers, and isolating attacks and compromised devices to prevent further contamination of network devices and patch management tools. In other words, the network zone segmentation function is for minimizing damage to a network caused by network attacks.

The above-mentioned classifications of the security functions provided by each of the network security devices connected to the subscriber network, according to whether the security functions are for maintaining the security of systems served by the network security devices, for maintaining the stability of the subscriber network, or for managing and administering the systems served by the network security devices, can be summarized as indicated in Table 2, which presents a plurality of security function sections, divisions, groups, and classes and scores given to the respective security function classes in operation 120.

TABLE 2

| | | | | |
|---|---|---|---|---|
| Sections | Divisions | Groups | Classes | Scores |

| | | | |
|---|---|---|---|
| System Security | User Access | ID/Password Method | 1 |
| Maintenance | Control | PKI Method | 3 |
| | | Biometric Authentication | 6 |
| | | Method | |
| | System Resource | Secure OS | 10 |
| | Access Control | | |
| | Additional Functions | Stealth Function | 3 |
| | | Exclusive OS | 3 |
| | | Exclusive Hardware | 3 |
| | | Physical Equipment | 1 |
| | | Protection | |

| | | |
|---|---|---|
| Network | Fall-Back Function | 10 |
| Stability | Load Balancing Function | 10 |
| Maintenance | | |
| System | Automated Real-Time Signature Update | 10 |
| Management & | Centralized Security System Management | 10 |
| Administration | Monitoring Reports/Statistical Reports | 10 |
| | Management | |
| | High Usability Maintenance | 10 |
| | Automated Program Module/Patch Update | 10 |
| | Network Zone Segmentation | 10 |

In operation 220, the grading unit 220 gives scores to or applies weights to the security function sections, divisions, groups, and classes presented in Table 1 and/or Table 2. The scores and weights given by the grading unit 220 may be altered according to the rules of grading adopted by the grading unit 220. Table 3 presents an example of the scores and weights given by the grading unit 220.

TABLE 3

| Sections | | | | |
|---|---|---|---|---|
| [Highest Mark] | Divisions [Highest Mark] | Groups | Scores | Weights |
| Network | Detection Methods [30] | 0-10 | Low | 0.75 |
| Attack | | 11-20 | Medium | |
| Detection (A) | | 21-30 | High | |
| | Detection Targets [30] | 0-10 | Low | |
| | | 20 | Medium | |
| | | 30 | High | |

| | | | |
|---|---|---|---|
| Network Attack | 0-6 | Low | 0.75 |
| Handling (B) [20] | 7-13 | Medium | |
| | 14-20 | High | |
| System Security | 0-12 | Low | 0.50 |
| Maintenance (C) [30] | 13-20 | Medium | |
| | 21-30 | High | |
| Network Stability | 0 | Low | 0.25 |
| Maintenance (D) [20] | 10 | Medium | |
| | 20 | High | |
| System Management & | 0-20 | Low | 0.33 |
| Administration (E) [60] | 21-40 | Medium | |
| | 41-60 | High | |

In operation 130, the determination unit 230 determines a security level for the subscriber network by summing the scores of the security functions provided by the network security devices using Tables 1 through 3, as indicated in the following equation:
Security Level of Subscriber Network=¾(A+B)+C+¼D+⅓E.
A perfect raw score that can be obtained by subscriber networks is 190. In order to easily interpret scores obtained by subscriber networks, the raw scores may be scaled to be within the range of 1 to 100, for example, by using the above equation, and then, the security levels of the subscriber networks may be determined based on the scaled scores.

Table 4 presents an example of network security levels, respective corresponding scaled score ranges, and how secure subscriber networks given the respective network security levels would be.

TABLE 4

| Network | Scaled | Security of Subscriber |
|---|---|---|
| Security Levels | Score Ranges | Networks |
| E1 | Over 90 | High (Most Secure) |
| E2 | Over 70 | Medium High |
| E3 | Over 50 | Medium |
| E4 | Over 30 | Medium Low |
| E5 | Below 30 | Low (Least secure) |

The information receiving unit 200, the classification unit 210, the grading unit 220, and the determination unit 230 of FIG. 2 may be realized using predetermined programs that can be executed in the above-described manner.

In addition, operations 100, 110, 120, and 130 of FIG. 1 may be embodied as software programs using a typical programming method or may be embodied as hardware devices.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the present invention can be easily construed by one of ordinary skill in the art.

According to the present invention, information regarding a plurality of security functions provided by each of a plurality of network security devices connected to a network is collected, and the security functions are classified according to their types, purposes of use, and priority levels. Scores are given to the security functions using weights with reference to the classification results, and a security level for the network is determined by summing the scores of the security functions provided by each of the network security devices. Therefore, it is possible to objectively evaluate how much secure a network is against cyber attacks launched internally or externally upon the network. In addition, it is possible to evaluate security functions provided by network security devices in a network in advance and enhance the performance of the security functions based, on the evaluation results.

While the present invention has been particularly shown and described with reference to exemplary embodiments thereof, it will be understood by those of ordinary skill in the art that various changes in form and details may be made therein without departing from. the spirit and scope of the present invention as defined by the following claims.

What is claimed is:

1. A method of evaluating the security of a subscriber network comprising:
receiving a plurality of pieces of information regarding a plurality of security functions provided by a plurality of network security devices connected to the subscriber network;
classifying the security functions according to the types, the purposes of use, and the priority levels of the security functions for each of the network security devices;
giving scores to and applying weights to the security functions with reference to the classification results; and
determining a security level for the subscriber network by summing the scores given to the security functions.

2. The method of claim 1, wherein the classifying the security functions comprises classifying the security functions into a network attack detection section that includes security functions that detecting a network attack launched internally or externally upon the subscriber network and a network attack handling section that includes security functions that respond to a network attack to protect the subscriber network.

3. The method of claim 2, wherein the classifying the security functions further comprises classifying the security functions belonging to the network attack detection section into a packet analysis level group that includes security functions that detect a network attack by performing packet analysis, a correlation analysis level group that includes security functions that detect a network attach by performing correlation analysis to detect an anomaly, and a detection pattern application level group that includes security functions that detect a network attack by using a detection pattern to detect a network attack launched upon the subscriber network.

4. The method of claim 3, wherein the classifying the security functions further comprises classifying the security functions belonging to the packet analysis level group into a packet level analysis class that includes security functions that perform network attack detection analysis with reference to IP header information, a session level analysis class that includes security functions that manage session state information and determine whether sessions are normal based on the session state information, and an application level analysis class that includes security functions that perform network attack detection analysis by analyzing all the contents of data transmitted inside the subscriber network.

5. The method of claim 3, wherein the classifying the security functions further comprises classifying the security functions belonging to the correlation analysis level group into a fixed threshold application class that includes security functions that set a fixed threshold regardless of the state of the subscriber network, a variable threshold application class that includes security functions that set a variable threshold which is flexibly determined according to the state of the subscriber network, a single information correlation analysis class that includes security functions that gather correlation analysis data from only one server, and a multiple information correlation analysis class that includes security functions that gather the correlation analysis data from a plurality of servers, according to how the security functions set a threshold and how the security functions collect information.

6. The method of claim 3, wherein the classifying the security functions further comprises classifying the security functions belonging to the detection pattern application level group into a signature-type pattern class that includes security functions that are used when a detection pattern is published, a weakness information pattern class that includes security functions that are based on published weakness information, and a protocol inspection class that includes security functions that determine how predetermined protocols are proper.

7. The method of claim 2, wherein the classifying the security functions further comprises classifying the security functions belonging to the network attack detection section into an abnormal excessive traffic detection group, a virus/worm detection group, and a typical hacking detection group, according to the threats they detect.

8. The method of claim 2, wherein the classifying the security functions further comprises classifying the security functions belonging to the network attack handling section into a packet control group that includes security functions that disallow the transmission of packets associated with a network attack and a bandwidth control group that includes security functions that block packets that are outside an allotted bandwidth.

9. The method of claim 8, wherein the classifying the security functions further comprises classifying the security functions belonging to the packet control group into a packet level control class that includes security functions that perform packet control on a packet level, a session level control class that includes security functions that perform packet control on a session level, and a content level control class that includes security functions that perform packet control on a packet content level.

10. The method of claim 8, wherein the classifying the security functions further comprises classifying the security functions belonging to the bandwidth control group into a fixed threshold application class that includes security functions that perform bandwidth control using a predefined threshold for network attacks and a variable threshold application class that includes security functions that perform bandwidth control using a variable threshold obtained through self-learning according to the circumstances in the subscriber network.

11. The method of claim 1, wherein the classifying the security functions further comprises classifying the security functions into a system security maintenance section that includes security functions that maintain the security of systems that are connected to the network security devices via the subscriber network and are served by the network security devices, a network stability maintenance section that includes security functions that transmit packets while maintaining the stability of the subscriber network, and a system management/administration section that includes security functions that manage and administer the systems served by the network security devices to operate smoothly.

12. The method of claim 11, wherein the classifying the security functions further comprises classifying the security functions belonging to the system security maintenance section into an ID/password method class, a public key infrastructure (PKI) method class, and a biometric authentication class according to how the security functions control users' attempts to access the systems served by the network security devices.

13. The method of claim 11, wherein the classifying the security functions further comprises classifying the security functions belonging to the system security maintenance section into a secure OS class that includes security functions that prevent unauthorized users from accessing system resources using the Secure OS according to whether the security functions use the secure OS to control users' attempts to access the system resources.

14. The method of claim 11, wherein the classifying the security functions further comprises classifying the security functions belonging to the system security maintenance section into a stealth function class that includes security functions that prevent information regarding some functions of the systems served by the network security devices from being exposed, an exclusive OS class that includes security functions that use an exclusive OS for each of the systems served by the network security devices, an exclusive hardware class that includes security functions that use an exclusive hardware device for each of the systems served by the network security devices, and a physical equipment protection function that includes security functions that physically protect the systems served by the network security devices, according to the types of additional functions that the security functions provide.

15. The method of claim 11, wherein the classifying the security functions further comprises classifying the security functions belonging to the network stability maintenance section into a fall-back function group and a load balancing function group according to whether the security functions also provide either a fall-back function or a load balancing function, wherein the fall-back function enables network services to be provided seamlessly even when the subscriber network malfunctions, and the load balancing function enables workloads to be uniformly distributed over a plurality of devices connected to the subscriber network.

16. The method of claim 11, wherein the classifying the security functions further comprises classifying the security functions belonging to the system management/administration section into an automated real-time signature update class, a centralized security system management class, a monitoring reports/statistical reports management class, a high usability maintenance class, an automated program module/patch update class, and a network zone segmentation class according to whether systems on which the security functions belonging to the system management/administration section are performed provide an automated real-time signature update function, a centralized security system management function, a system operation monitoring reports/statistical reports management function, a high usability maintenance function, an automated program module/patch update function, or a network zone segmentation function.

17. An apparatus for evaluating the security of a subscriber network comprising:
an information receiving unit which receives a plurality of pieces of information regarding a plurality of security functions provided by each of a plurality of network security devices connected to the subscriber network;
a classification unit which classifies the security functions according to the types, the purposes of use, and the priority levels of the security functions for each of the network security devices;
a grading unit which gives scores to and applies weights to the security functions with reference to the classification results; and
a determination unit which determines a security level for the subscriber network by summing the scores given to the respective security functions.
